(19) United States
(12) Patent Application Publication
(10) Pub. No.: US 2011/0200227 A1
(43) Pub. Date: Aug. 18, 2011

(54) ANALYSIS OF DATA FROM MULTIPLE TIME-POINTS

(75) Inventors: Luca Bogoni, Philadelphia, PA (US); Charles Henri Florin, Trenton, NJ (US)

(73) Assignee: SIEMENS MEDICAL SOLUTIONS USA, INC., Malvern, PA (US)

(21) Appl. No.: 13/028,462

(22) Filed: Feb. 16, 2011

Related U.S. Application Data
(60) Provisional application No. 61/305,218, filed on Feb. 17, 2010.

(51) Int. Cl. G06K 9/00

(52) U.S. Cl. 382/103

(57) ABSTRACT

Described herein is a technology for facilitating analysis of data across multiple time-points. In one implementation, first and second images acquired at respective first and second different time-points are received. In addition, first and second findings associated with the first and second images respectively are also received. The first and second findings are associated with at least one region of interest. A correspondence between the first and second findings may be automatically determined by aligning the first and second findings. A longitudinal analysis result may then be generated by correlating the first and second findings.

### CROSS-REFERENCE TO RELATED APPLICATION

The present application claims the benefit of U.S. provisional application No. 61/305,218 filed Feb. 17, 2010, the entire contents of which are herein incorporated by reference.

### TECHNICAL FIELD

The present disclosure relates generally to automated or partially-automated data analysis, and more particularly, to analysis of data from multiple time-points.

### BACKGROUND

The field of medical imaging has seen significant advances since the time X-Rays were first used to determine anatomical abnormalities. Medical imaging hardware has progressed in the form of newer machines such as Medical Resonance Imaging (MRI) scanners, Computed Axial Tomography (CAT) scanners, etc. Because of large amount of image data generated by such modern medical scanners, there has been and remains a need for developing image processing techniques that can automate some or all of the processes to determine the presence of anatomical abnormalities in scanned medical images.

Digital medical images are constructed using raw image data obtained from a scanner, for example, a CAT scanner, MRI, etc. Digital medical images are typically either a two-dimensional (“2-D”) image made of pixel elements or a three-dimensional (“3-D”) image made of volume elements (“voxels”). Four-dimensional (“4-D”) medical images containing information about 3-D volumes moving in time are also known. Such 2-D, 3-D or 4-D images are processed using medical image recognition techniques to determine the presence of anatomical structures such as lesions, cysts, tumors, polyps, etc. Given the amount of image data generated by any given image scan, however, it is preferable that an automatic technique should point out anatomical features in the selected regions of an image to a doctor for further diagnosis of any disease or condition.

Automatic image processing and recognition of structures within a medical image is generally referred to as Computer-Aided Detection (CAD). A CAD system can process medical images and identify anatomical structures including potential abnormalities for further review. Such possible abnormalities are often called candidates and are considered to be generated by the CAD system based upon the medical images.

The diagnostic capability of the CAD system is greatly enhanced by considering, amongst other types of data, image data acquired during prior examinations. For example, in the preparation for a follow-up examination, prior studies associated with a given patient may be pre-fetched to a working environment, such as a workstation or an electronic Picture Archiving and Communication Systems (PACS), so as to expedite the review of the newest acquisition of data in the context of the prior studies. At that time, the radiologist may review the newly acquired images for new findings or changes in findings by comparing the new findings with the prior examinations' reports for the same patient.

However, while the loading of multiple images across different time-points or different modalities has become common practice, conventional systems analyze and present each image separately. For example, the individual findings annotated in reports for prior examinations are typically not present in the images acquired during the current examination. Additionally, the current image is not automatically correlated with prior images. Instead, the radiologist must review the current image and spend a considerable amount of time locating the findings in the prior images and manually determine any changes in the findings.

Accordingly, it would be desirable to provide a system that automatically processes information from multiple time-point images to facilitate better detection, visualization and assessment of any abnormalities in the images.

### SUMMARY

A technology for facilitating analysis of data across multiple time-points is described herein. In one implementation, first and second images acquired at respective first and second different time-points are received. In addition, first and second findings associated with the first and second images respectively are also received. The first and second findings are associated with at least one region of interest. A correspondence between the first and second findings may be automatically determined by aligning the first and second findings. A longitudinal analysis result may then be generated by correlating the first and second findings.

This summary is provided to introduce a selection of concepts in a simplified form that are further described below in the following detailed description. It is not intended to identify features or essential features of the claimed subject matter, nor is it intended that it be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings.

FIG. 1 shows an exemplary system;

FIG. 2 shows an exemplary method;

FIG. 3 shows an exemplary image registration method; and

FIG. 4 illustrates an exemplary propagation of findings across multiple time-points.

### DETAILED DESCRIPTION

In the following description, numerous specific details are set forth such as examples of specific components, devices, methods, etc., in order to provide a thorough understanding of embodiments of the present invention. It will be apparent, however, to one skilled in the art that these specific details need not be employed to practice embodiments of the present invention. In other instances, well-known materials or methods have not been described in detail in order to avoid unnecessarily obscuring embodiments of the present invention. While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

The term “x-ray image” as used herein may mean a visible x-ray image (e.g., displayed on a video screen) or a digital representation of an x-ray image (e.g., a file corresponding to the pixel output of an x-ray detector). The term “in-treatment x-ray image” as used herein may refer to images captured at any point in time during a treatment delivery phase of a radiosurgery or radiotherapy procedure, which may include times when the radiation source is either on or off. From time to time, for convenience of description, CT imaging data may be used herein as an exemplary imaging modality. It will be appreciated, however, that data from any type of imaging modality including but not limited to X-Ray radiographs, MRI, CT, PET (positron emission tomography), PET-CT, SPECT, SPECT-CT, MR-PET, 3-D ultrasound images or the like may also be used in various embodiments of the invention.

Unless stated otherwise as apparent from the following discussion, it will be appreciated that terms such as “segmenting,” “generating,” “registering,” “determining,” “aligning,” “positioning,” “processing,” “computing,” “selecting,” “estimating,” “detecting,” “tracking” or the like may refer to the actions and processes of a computer system, or similar electronic computing device, that manipulate and transform data represented as physical (e.g., electronic) quantities within the computer system's registers and memories into other data similarly represented as physical quantities within the computer system memories or registers or other such information storage, transmission or display devices. Embodiments of the methods described herein may be implemented using computer software. If written in a programming language conforming to a recognized standard, sequences of instructions designed to implement the methods can be compiled for execution on a variety of hardware platforms and for interface to a variety of operating systems. In addition, embodiments of the present invention are not described with reference to any particular programming language. It will be appreciated that a variety of programming languages may be used to implement embodiments of the present invention.

As used herein, the term “image” refers to multi-dimensional data composed of discrete image elements (e.g., pixels for 2-D images and voxels for 3-D images). The image may be, for example, a medical image of a subject collected by computer tomography, magnetic resonance imaging, ultrasound, or any other medical imaging system known to one of skill in the art. The image may also be provided from non-medical contexts, such as, for example, remote sensing systems, electron microscopy, etc. Although an image can be thought of as a function from R³ to R or R⁷, the methods of the inventions are not limited to such images, and can be applied to images of any dimension, e.g., a 2-D picture or a 3-D volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

The following description sets forth one or more implementations of systems and methods that facilitate processing of image data in its temporal context. In one implementation, the present framework presents information that has been accrued over time in a systematic and efficient manner to improve the workflow of a user of a computer-aided detection (CAD) system. Prior findings may be automatically correlated with the current findings to facilitate longitudinal analysis and better assessment of any detected abnormalities. In addition, the present framework may propagate prior findings to the current study, thereby eliminating the need to manually locate these prior findings. Even further, characteristics identified by the radiologist as clinically relevant for a given finding may be pre-computed for the physician to review when desired.

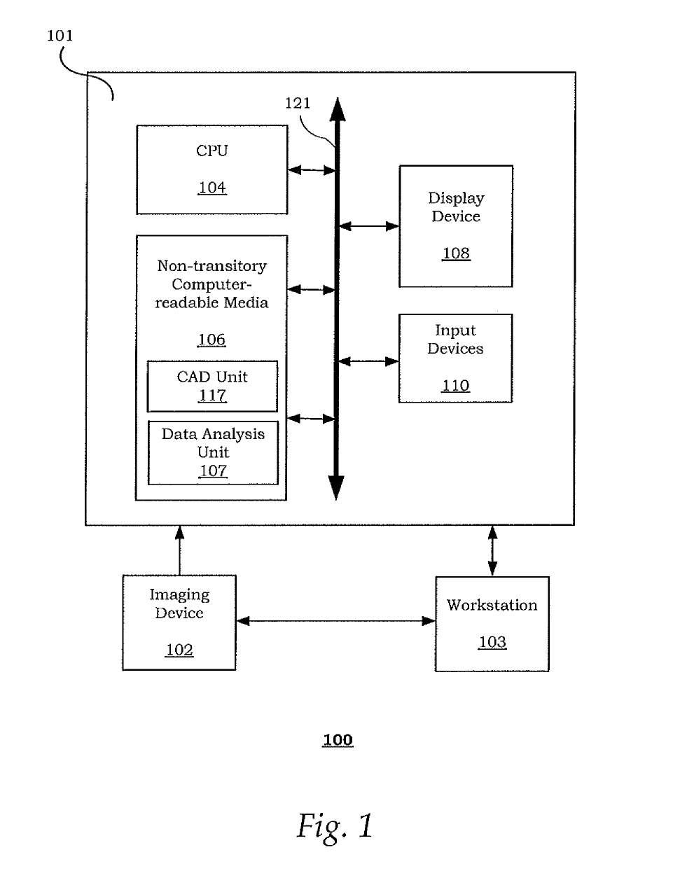

FIG. 1 shows a block diagram illustrating an exemplary system 100. The system 100 includes a computer system 101 for implementing the framework as described herein. The computer system 101 may be further connected to an imaging device 102 and a workstation 103, over a wired or wireless network. The imaging device 102 may be a radiology scanner such as a magnetic resonance (MR) scanner or a CT scanner.

The computer system 101 may be a desktop personal computer, a portable laptop computer, another portable device, a mini-computer, a mainframe computer, a server, a storage system, a dedicated digital appliance, or another device having a storage sub-system configured to store a collection of digital data items. In one implementation, the computer system 101 comprises a processor or central processing unit (CPU) 104 coupled to one or more non-transitory computer-readable media 106 (e.g., computer storage or memory), display device 108 (e.g., monitor) and various input devices 110 (e.g., mouse or keyboard) via an input-output interface 121. The computer system 101 may further include support circuits such as a cache, power supply, clock circuits and a communications bus.

It is to be understood that the present technology may be implemented in various forms of hardware, software, firmware, special purpose processors, or a combination thereof. In one implementation, the techniques described herein may be implemented as computer-readable program code tangibly embodied in the non-transitory computer-readable media 106. In particular, the techniques described herein may be implemented by a data analysis unit 107. The non-transitory computer-readable media 106 may include random access memory (RAM), read only memory (ROM), magnetic floppy disk, flash memory, and other types of memories, or a combination thereof. The computer-readable program code is executed by the CPU 104 to process data (e.g., MR or CT images, findings) from the imaging device 102 (e.g., MR or CT scanner) or from a computer-aided detection (CAD) unit 117. The CAD unit 117 may be implemented locally on the non-transitory computer-readable media 106, or remotely in an external server. In addition, the CAD unit 117 may serve to pre-process the image data prior to processing by the data analysis unit 107 by performing one or more CAD techniques to generate one or more findings, which will be described later.

In one implementation, the computer system 101 also includes an operating system and microinstruction code stored in the non-transitory computer-readable media 106. The various techniques described herein may be implemented either as part of the microinstruction code or as part of an application program or software product, or a combination thereof, which is executed via the operating system. The computer system 101 is a general-purpose computer system that becomes a specific purpose computer system when executing the computer-readable program code. The computer-readable program code is not intended to be limited to any particular programming language and implementation thereof. It will be appreciated that a variety of programming languages and coding thereof may be used to implement the teachings of the disclosure contained herein. Various other peripheral devices, such as additional data storage devices and printing devices, may be connected to the computer system 101.

The workstation 103 may include a computer and appropriate peripherals, such as a keyboard and display, and can be operated in conjunction with the entire system 100. For example, the workstation 103 may communicate with the imaging device 102 so that the image data collected by the imaging device 102 can be rendered at the workstation 103 and viewed on the display. The workstation 103 may include a user interface that allows the radiologist or any other skilled user (e.g., physician, technician, operator, scientist, etc.), to manipulate the image data or specify preferences for visualization or temporal management. For example, the user may identify regions of interest in the image data, or annotate the regions of interest using pre-defined descriptors via the user interface. The user may also specify various parameters to tailor the longitudinal and/or cross-sectional analysis and any report generated in accordance with the present framework, as will be described later.

Further, the workstation 103 may communicate directly with the computer system 101 to display image data. For example, a user may interactively manipulate the displayed representation of the image data and view it from various viewpoints and in various reading modes or user-defined preferences. The user may be provided with various options to customize the display. For example, the user may choose to overlay prior findings on the current image or select various graphical representations for presenting correlated information. These and other exemplary features will be described in more detail later.

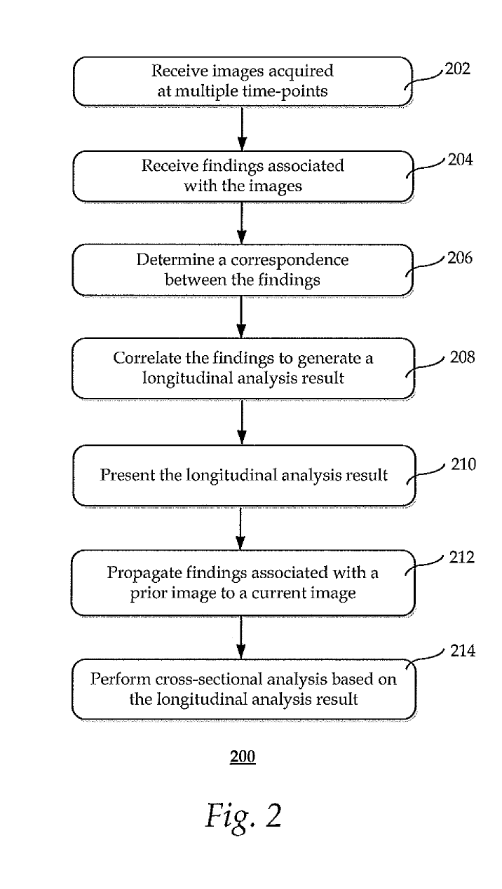

FIG. 2 shows an exemplary data analysis method 200. In one implementation, the exemplary method 200 is implemented by the data analysis unit 107 in the computer system 101, as previously described with reference to FIG. 1. It should be noted that in the discussion of FIG. 2 and subsequent figures, continuing reference may be made to elements and reference numerals shown in FIG. 1.

At step 202, the computer system 101 receives at least first and second images acquired at first and second different time-points respectively. The images may be stored locally on computer-readable media 106 or remotely in an external server. The images may include digitized images acquired by imaging device 102. The images may be acquired by, for example, magnetic resonance (MR) imaging, computed tomography (CT), helical CT, x-ray, positron emission tomography (PET), fluoroscopic, ultrasound, single photon emission computed tomography (SPECT), or a combination thereof. The images may be binary (e.g., black and white) or grayscale. In addition, the images may be two-dimensional, three-dimensional, or any other dimensionality.

In one implementation, the images are acquired during radiological examinations at different time-points (t₁, t₂, . . . , tₙ). The durations between the time-points (t₁, t₂, . . . , tₙ) may be constant or variable. The first instance of a radiological examination of the patient is referred to as the baseline study, and is made at time-point t₁. The next examination may be performed at t₂, and so forth, and the current examination performed at tₙ. The baseline study may include, for example, acquisition of image data from multiple modalities (e.g., CT, MRI, PET/CT, etc.) as warranted by the clinical indication and patient management protocol.

The image data may be pre-processed, either automatically by the CAD unit 117, manually by a skilled user (e.g., radiologist), or a combination thereof. Various types of pre-processing may be performed. For example, the images may be pre-filtered to remove noise artifacts or to enhance the quality of the images for ease of evaluation. Pre-processing may also include segmentation, annotation, marking or tagging of regions-of-interest (e.g., lesions, tumors, masses, etc.) which are identified for further study and interpretation.

More particularly, the image data may be reviewed, segmented and annotated either manually or automatically, to generate relevant findings. For example, a physician may review the baseline study and annotate any relevant findings in a report using, for example, a dictation mechanism, electronic input device and/or user interface at, for example, workstation 103. Alternatively, or in combination thereof, the regions-of-interest (ROIs) may be detected automatically by, for example, the CAD unit 117 or multiple CAD systems specializing in different morphological and pathological characteristics. In one implementation, the CAD unit 117 performs a CAD technique to automatically determine findings associated with the image data, A CAD technique may employ a segmentation method to partition the images into one or more regions-of-interest. Exemplary segmentation methods include, for example, partitioning the image based on edges, morphology, changes or transitions in intensity, color, spectrographic information, etc.

At 204, prior findings associated with the images are received. In particular, at least first and second findings associated with the first and second images respectively may be retrieved from, for example, computer-readable media 106. As described previously, the prior findings are associated with a region-of-interest (ROI), and may be manually determined by a user or automatically detected by the CAD unit 117 during pre-processing of the image data. The prior findings are retrieved from, for example, a structured report, a written report, a patient file, a scanned document, a database or a Picture Archiving and Communication Systems (PACS). The retrieval may be performed manually (or user-guided) or automatically. If automatic, the retrieval may be guided by a set of rules associated with a patient characteristic (e.g. name, patient identification number, etc.), and/or image characteristic (e.g. acquisition modality, date, etc.).

At 206, a correspondence between the findings in the image data sets is determined. An image registration technique may be used to align multiple images or findings according to one coordinate system. This is generally performed so as to account for image differences that occur during acquisition at different time-points. These differences may exist due to, for example, changes in the patient's orientation, pose, heartbeat, anatomy or respiration, or differences in imaging modality, sensor, or viewpoint. Additionally, differences may be caused by local deformation of tissue, such as compression or inflation, onset or progression of disease, gain or loss of weight due to, for example, therapy, etc. Image registration may be performed by spatially aligning the target image with a reference image. The alignment may be performed manually, semi-automatically (or interactively) or fully automatically.

To determine the correspondence between the findings, a user may match the ROIs (or findings or landmarks) between data sets. For example, a user interface may be provided at computer system 101 or workstation 103 to receive the user's indication of the correspondence between the findings. This process may be particularly useful where there is a significant change in appearance of the images or the images are obtained by different modalities. Alternatively, a semi-automated determination of the correspondence may be performed by allowing the user to interactively guide the alignment by, for example, identifying or disregarding ROIs (or findings) to be used in the alignment process. In another implementation, the data analysis unit 107 automatically determines the correspondence by applying an image registration technique to compute a transformation model on the image data. Transformation models that may be used include linear transformations (e.g., translation, rotation, scaling, other affine transforms, etc.) and/or non-rigid (or elastic) transformations (e.g., radial basis functions, physical continuum models, large deformation fields, etc.).

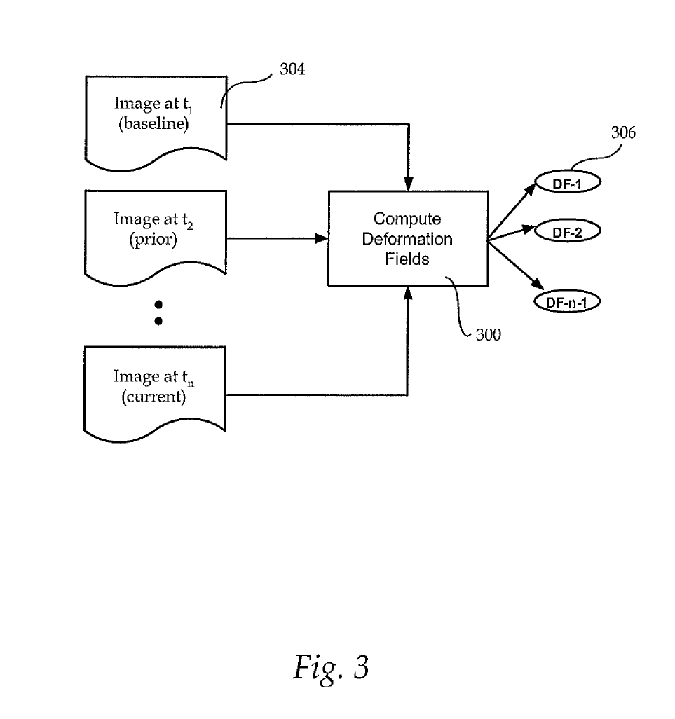

FIG. 3 shows an exemplary image registration method 300 that relates datasets across multiple time-points. More particularly, the image registration method 300 computes deformation fields 306 to apply to images 304, which were acquired at multiple time-points (t₁, t₂, . . . , tₙ). This method 300 results in (n−1) deformation fields 306 (DF-(1) to DF-(n−1)) that represent the alignment differences between the (n−1) target images and a reference image. For example, each deformation field may relate the prior image to the current (or newly acquired) image that is chosen as the reference image for alignment purposes. It should be noted that other registration mechanisms, such as those with incremental improvements of alignment, multi-pass or hierarchical registration, may also be used.

Referring back to FIG. 2, at 208, the associated findings are automatically correlated by the data analysis unit 107 to generate a longitudinal analysis result. A longitudinal analysis generally refers to a correlational study that involves repeated observations of a medical condition over a period of time. The data analysis unit 107 may process and correlate findings across prior datasets and the current (or newly acquired) dataset(s) to detect the existence and/or progression of one or more medical conditions over time.

In one implementation, the data analysis unit 107 analyzes or identifies a certain medical condition or disease (i.e. pathology-specific). Alternatively, the data analysis unit 107 includes multiple pathology-specific CAD tools (e.g., lung CAD, pulmonary embolism CAD, etc.) to identify a multiplicity of medical conditions. Processing may be performed image-by-image (i.e. image-specific) or on a series of images (i.e. dataset) as a whole. Image-specific processing may be performed by analyzing each image independently from other images so as to detect a given pathology. Dataset processing, on the other hand, is performed by analyzing and correlating a series of images as a whole in the temporal context.

In particular, each image (and each deformation field) may be automatically processed to determine any change (or rate of change) in an ROI. The correlation between the images may indicate the presence or progression of a given pathology. For example, each image may present characteristics that are consistent with the presence of a lesion. The characteristics and time-difference between the images may suggest whether or not a finding is malignant (or clinically relevant). A lesion that persists over time, for instance, is more likely to be malignant than one that occurs intermittently.

In one implementation, the data analysis unit 107 computes, based on the prior findings, a longitudinal analysis result associated with a characteristic of the ROI. The characteristics may be indicative of whether the finding is clinically relevant or benign. Exemplary characteristics include volumetric properties (e.g., size, density, shape, etc.) or intensity-based properties. The computation of the longitudinal analysis result may be performed in accordance with a user-defined protocol via a user interface. For example, the user may select, from a menu, one or more characteristics to be analyzed. Alternatively, the data analysis unit 107 automatically pre-computes certain characteristics so that they are readily available to the user during review.

A user interface may also be provided to allow the user to query any given ROI (or location) by selecting it with an input device 110 (e.g., mouse, keyboard) to obtain any additional information, including findings associated with a prior study. Alternatively, or in combination thereof, a gallery (or list) of findings may be provided to allow the user to directly navigate to a specific ROI (or location), and to expand any additional information associated with it. For instance, the data analysis unit 107 may present, at the display device 108, a gallery that shows the same ROI across multiple time-points. Additional information may be provided at each time-point.

In one implementation, the longitudinal analysis result comprises a summary of the progression of the medical condition (or disease) associated with an ROI. The persistence of the findings across multiple time-points may also be characterized. The user may select the ROI (e.g., sentinel nodules), or the data analysis unit 107 may automatically summarize the medical condition related to all the ROIs so as to present a trend of the disease. The user may select an anatomical area as an ROI, such as specific lobes or quadrants of the lung, or a segment of the liver. This allows the user to monitor either the stability or progression of the disease, or the response to treatment or therapy.

At 210, the longitudinal analysis result is presented at, for example, a display device 108 and/or at the workstation 103 for user review, and/or included in a structured report to support a diagnosis with objective evidence. The present framework may also be used to assess the effectiveness of a prescribed treatment or therapy. For example, the size of a tumor may be monitored over time by automatically correlating the current image with the prior image datasets to determine any decrease in size that may be attributed to the treatment. The user may choose to present the progression of characteristics in a graphical representation, such as a pictorial graph or a bar chart. Additionally, clinical guidelines may be presented to indicate the likelihood of malignancy given the progression of the selected characteristics.

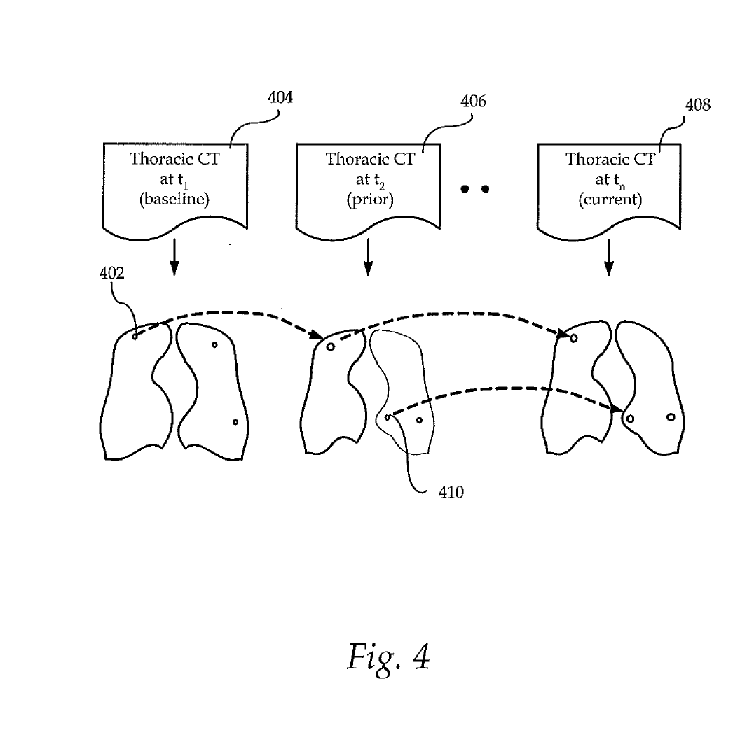

At 212, findings from an image acquired during a prior study may be propagated to the image in the current study. For example, markings (e.g., arrows or highlighting) of regions-of-interest (ROIs) previously identified in the prior study may be overlaid on the current image. FIG. 4 illustrates an exemplary propagation of ROIs identified in prior studies across multiple time-points to the current time-point. More particularly, ROI 402, which was identified in the baseline image 404, is propagated to the prior image 406 and subsequently to the current image 408. Similarly, ROI 410, which was identified at an intermediary time-point t₂ in prior image 406, is propagated across multiple time-points to the current image 408. Propagation is performed by taking into account one or more alignment transformations.

The propagation of the findings from the prior study to the current study may be performed if a pre-determined criterion is satisfied. In one implementation, a user interface is provided to allow the user to specify the criterion to determine whether the findings from the prior study are propagated to the current study. For example, the user may choose to display only findings that persist over time and/or suppress any findings that have disappeared or been dismissed by the user after evaluation (e.g., below a given threshold size). The user may also choose to show all ROIs that satisfy a certain user-defined criteria, such as size, density or other characteristic. The user may also specify certain display preferences, such as labeling certain ROIs with different colors, so as to facilitate visualization and detection of clinically relevant ROIs. It is understood that other preferences may also be selected by the user.

Besides prior findings, the nomenclature that characterizes the prior study may also be propagated to the current study. The nomenclature may include, for example, the modality used to acquire the images in the prior study, the time difference between the prior and the current studies, and so forth. Such information may be color coded to indicate that it is associated with the prior study, and not the current study.

At 214, a cross-sectional analysis based on the longitudinal analysis result may be performed. More particularly, the data analysis unit 107 may collect and/or retrieve information associated with a population of patients who have a similar medical condition. The data analysis unit 107 may retrieve the information from a database located in, for example, the non-transitory computer-readable media 106 or a remote server (not shown). Such information may include the longitudinal analysis results or the reports generated by the data analysis unit 107 in accordance with the present framework. For instance, after the data analysis unit 107 generates a report associated with a patient, it may be stored in the database so that it may be retrieved for cross-sectional analysis.

In one implementation, the cross-sectional analysis includes providing a relative progression of the medical condition with respect to the population of similarly affected patients. In addition, patients who share the same trends of the medical condition may be identified, so as to allow the user or physician to assess the effectiveness of the patient management for a particular patient and to adjust the treatment if necessary. The patients may be clustered in several categories (e.g., stable, mild, intermediate, advanced, etc.) of the medical condition. These categories may then be matched to the disease stage and management protocols.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

Further, although method or process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

1. A data analysis method, comprising:
(i) receiving first and second images acquired at respective first and second different time-points;
(ii) receiving first and second findings associated with the first and second images respectively, wherein the first and second findings are associated with at least one region of interest;
(iii) determining, by a processor, a correspondence between the first and second findings by aligning the first and second findings; and
(iv) generating, by the processor, a longitudinal analysis result by correlating the first and second findings.

2. The method of claim 1 wherein the step (ii) comprises retrieving, by the processor from a computer-readable media, the first and second findings based on a set of rules associated with a patient characteristic or an image characteristic.

3. The method of claim 1 further comprising performing a computer-aided detection technique to automatically determine the first and second findings.

4. The method of claim 1 wherein the step (iii) comprises performing an image registration technique to spatially align the first and second images with a reference image.

5. The method of claim 1 wherein the longitudinal analysis result is associated with a change in a characteristic of the region of interest.

6. The method of claim 5 wherein the characteristic comprises at least one volumetric or intensity-based property.

7. The method of claim 5 further comprising receiving, via a user interface, a user selection of the characteristic to be analyzed.

8. The method of claim 5 further comprising presenting a progression of the characteristic in a graphical representation.

9. The method of claim 1 further comprising receiving, via a user interface, a user selection of the region of interest to be analyzed.

10. The method of claim 9 further comprising presenting the first or second finding associated with the region of interest.

11. The method of claim 10 further comprising presenting the region of interest at the first and second time-points.

12. The method of claim 1 wherein the longitudinal analysis result comprises a summary of a progression of a medical condition associated with the region of interest.

13. The method of claim 1 further comprising propagating the first finding to the second image.

14. The method of claim 13 wherein the first finding is propagated to the second image if a pre-determined criterion is satisfied.

15. The method of claim 1 further comprising propagating a nomenclature associated with the first image to the second image.

16. The method of claim 1 further comprising performing, based on the longitudinal analysis result and by the processor, a cross-sectional analysis associated with a population of patients with a similar medical condition.

17. The method of claim 16 wherein the performing the cross-sectional analysis comprises providing a relative progression of the medical condition with respect to the population of patients.

18. The method of claim 16 wherein the performing the cross-sectional analysis comprises identifying one or more patients who share a same trend of the medical condition.

19. A non-transitory computer-readable medium embodying a program of instructions executable by machine to perform steps for data analysis, the steps comprising:
(i) receiving first and second images acquired at respective first and second different time-points;
(ii) receiving first and second findings associated with the first and second images respectively, wherein the first and second findings are associated with at least one region of interest;
(iii) determining a correspondence between the first and second findings by aligning the first and second findings; and
(iv) generating a longitudinal analysis result by correlating the first and second findings.

20. A data analysis system, comprising:
a memory device for storing non-transitory computer readable program code; and
a processor in communication with the memory device, the processor being operative with the computer readable program code to
(i) receive first and second images acquired at respective first and second different time-points;
(ii) receive first and second findings associated with the first and second images respectively, wherein the first and second findings are associated with at least one region of interest;
(iii) determine a correspondence between the first and second findings by aligning the first and second findings; and
(iv) generate a longitudinal analysis result by correlating the first and second findings.
